(19) United States
(12) Patent Application Publication
(10) Pub. No.: US 2014/0210583 A1
(43) Pub. Date: Jul. 31, 2014

(54) Electronic Equipment

(71) Applicant: Kabushiki Kaisha Toshiba, Tokyo (JP)

(72) Inventors: Noriaki Oodachi, Kanagawa (JP); Kenichirou Ogawa, Tokyo (JP); Hiroki Kudo, Kanagawa (JP); Akiko Yamada, Kanagawa (JP); Tetsu Shijo, Tokyo (JP); Hiroki Shoki, Kanagawa (JP); Shuichi Obayashi, Kanagawa (JP)

(73) Assignee: Kabushiki Kaisha Toshiba, Tokyo (JP)

(21) Appl. No.: 14/202,733

(22) Filed: Mar. 10, 2014

Related U.S. Application Data
(63) Continuation of application No. PCT/JP2012/057421, filed on Mar. 23, 2012.

(30) Foreign Application Priority Data
Sep. 28, 2011 (JP) 2011-212526

(51) Int. Cl. H01F 27/02; H01F 38/14

(52) U.S. Cl. CPC H01F 27/02; H01F 38/14
USPC 336/90

(57) ABSTRACT

There is provided an electronic equipment including: a first case that incorporates an electronic component; a second case having a first surface that is common with a surface of the first case, a second surface that has an angle with respect to the first surface and a third surface that has an angle with respect to the second surface; and electric power receiving coils built in parts that face respectively the second surface and the third surface.

### CROSS-REFERENCE TO RELATED APPLICATION

This application, is a continuation application (CA) based upon and claims the benefit of priority from Japanese Patent Applications No. 2011-212526, filed on Sep. 28, 2011; and International Application PCT/JP2012/057421, the International Filing Date of which is Mar. 23, 2012 the entire contents of which are incorporated herein by reference.

### FIELD

Embodiments described herein relate generally to an electronic equipment.

### BACKGROUND

Mobilization of electronic equipment has been proceeded, and accordingly, weight reduction of its power source has been sought. Conventionally, as power sources of electronic equipment including mobile devices, batteries such as lithium secondary batteries have been broadly used, but in the case where such a battery is used for electronic equipment that requires a large capacity of electric power, a weight of the battery becomes high, which causes a difficulty in portability.

Also, when charging a battery which is built in the electronic equipment, a power connector is usually connected to the electronic equipment so as to transmit electric power; however, there is a limit to downsize such power connector, which has been a bottleneck in downsizing the electronic equipment. Further, such power connectors have various designing shapes according to the kinds of the electronic equipment, thereby lacking their versatilities.

Then, as a method for supplying electric power to a mobile device without using such a power connector, wireless electric power transmission technology has been drawn attention. This wireless electric power transmission technology includes: disposing an electric power receiving means that is made of a coil and a magnetic material into a case of the electronic equipment; and supplying electric power thereto by an electric power transmitting means such as a coil which is disposed near the case of the electronic equipment.

### BRIEF DESCRIPTION OF THE DRAWINGS

FIG. 1 is a schematic view for illustrating a wireless electric power transmitting device of Example 1.

FIG. 2 is a schematic view for illustrating a modified example of an electric power receiving coil.

FIG. 3 is a schematic view for illustrating a wireless electric power transmitting device of Example 4.

FIGS. 4A and 4B are schematic views for illustrating a modified example of a conductor component that can be built in a second case.

FIG. 5 is a schematic view for illustrating a circular spiral antenna.

FIG. 6 is a schematic view for illustrating a rectangular spiral antenna.

FIG. 7 is a schematic view for illustrating the electric power receiving coils including a cable.

FIG. 8 is a schematic view for illustrating a structure of a printer in the case of applying this embodiment to the printer.

FIG. 9 is a schematic view for illustrating a structure of an air cleaner in the case of applying this embodiment to the air cleaner.

FIG. 10 is a schematic view for illustrating a structure of a vacuum cleaner in the case of applying this embodiment to the vacuum cleaner.

FIG. 11 is a schematic view for illustrating a structure of an electric vehicle in the case of applying this embodiment to the electric vehicle.

FIG. 12 is a schematic view for illustrating a modified example in which an insulator is not built in the second case.

### DETAILED DESCRIPTION

An electronic equipment of an embodiment includes: a first case that incorporates an electronic component; a second case having a first surface that is common with a surface of the first case, a second surface that has an angle with respect to the first surface and a third surface that has an angle with respect to the second surface; and electric power receiving coils built in parts that face respectively the second surface and the third surface.

As described above, in the conventional wireless electric power transmission technology, the electric power receiving means including the coil and the magnetic material is disposed in the case of the electronic equipment.
According to this technology, by disposing the magnetic material near the coil, shapes of magnetic lines are changed. According to this change of the shapes of the magnetic lines, when a conductor component is disposed in an area where the magnetic lines are sparse, generation of eddy current can be suppressed. Since the eddy current causes the generation of an energy loss, a transmitting efficiency can be enhanced by such suppression of the generation of the eddy current. According to such conventional technique, when incorporating the coil into the equipment, by disposing the magnetic material so as to decrease the magnetic lines in the area where the conductor component such as an electronic component is positioned in the equipment, the wireless electric power transmission can be achieved with high efficiency.

However, in the conventional wireless electric power transmitting device which adopts the magnetic material, there has been a problem of generating such a loss due to the magnetic material. In addition, there was also a problem of increasing a cost and a weight of the magnetic material. The problem of such weight increment becomes serious particularly when the equipment that incorporates the coil is a mobile device represented by a notebook computer and a cellular phone, or a moving body represented by an electric vehicle, an electric motorcycle and a power-assisted bicycle.

The electronic equipment of this embodiment is to solve the above-mentioned conventional problems, and aims to provide a wireless electric power transmitting device that is capable of incorporating a coil into the equipment without using a magnetic material, which has been difficult in the conventional technique.

The electronic equipment of this embodiment includes: a first case that incorporates an electronic component; a second case having a first surface that is common with a surface of the first case, a second surface that has an angle with respect to the first surface and a third surface that has an angle with respect to the second surface; and electric power receiving coils built in parts that face respectively the second surface and the third surface.

According to such a structure, the shapes of the magnetic lines can be controlled by the electric power receiving coils, and their coupling with the electronic component can be smaller, whereby the wireless electric power transmission can be achieved with high efficiency.

In the electronic equipment of the above-described embodiment, the first surface of the first case and the second surface and the third surface of the second case are arranged so that they are in contact having angles with each other, and herein, this term of “having angles” means a state that these surfaces are in contact with each other without forming a single plane. Most preferably, two of these surfaces are in contact perpendicularly to each other.

The electronic equipment, of this embodiment receives electric power with the magnetic lines formed by electric power supplying coils that are disposed outside the case of this electronic equipment. Then, the electric power receiving coils are preferably arranged so that these magnetic lines may pass through the plural electric power receiving coils of the receiving side. For this, the plural electric power receiving coils are preferably arranged so that the center of each coil may be positioned on an arc of a circle that corresponds to the magnetic line, and the magnetic line may perpendicularly cross the plane of the coil near the center of the coil.

In the electronic equipment of the above-described Embodiment 1, it is preferable that the first surface is made of a conductor, and a conductivity of the conductor structuring the first surface is higher than an equivalent conductivity of the electronic component which is built in the first case. Thereby, the magnetic lines that leak toward the electronic component can be further limited by the first surface whose conductivity has a smaller loss than that of the electronic component, and the coupling between the electronic component and the magnetic line becomes smaller, whereby the transmission can be achieved with high efficiency.

Moreover, in the electronic equipment of the above-described Embodiment 1, the first surface is preferably made of an insulator. Thereby, if there is a magnetic line that leaks toward the electronic component, a loss caused by the coupling between the common surface and the magnetic line can be reduced.

Further, in the electronic equipment of the above-described embodiment, each of the second surface and the third surface is preferably made of an insulator.
Thereby, the magnetic lines pass through the second surface and the third surface, but a loss caused by this passage can be reduced.

Also, in the electronic equipment of the above-described embodiment, winding axes of the electric power receiving coils are preferably perpendicular to the second surface and the third surface respectively.
Thereby, a space inside the second case can be larger.

Further, in the electronic equipment of the above-described embodiment, a conductor component having a resonant frequency that is different from a frequency transmitted or received by the electric power supplying coil or the electric power receiving coil is preferably adopted as the conductor component to be disposed in the electronic equipment.
Thereby, since the number of the components that can be built in the case 2 is increased, a size of the case 1 can be reduced.

Moreover, in the electronic equipment of the above-described embodiment, the second case preferably incorporates a conductor component whose shadow, which is formed on a projected plane when the conductor component is illuminated with light at an arbitrary angle, has an area smaller than an area of the electric power receiving coil.
Thereby, since the number of the components that can be built in the case 2 is increased, the size of the case 1 can be reduced.

Also, in the electronic equipment of the above-described embodiment, the second case preferably incorporate a plurality of the conductor components.
Thereby, since the number of the components that can be built in the case 2 is further increased, the size of the case 1 can be further reduced.

Moreover, in the electronic equipment of the above-described embodiment, the electric power receiving coil is preferably made of a self-resonant coil.
Thereby, a distance between the electric transmitting coil and the electric power receiving coil can be much larger, positions of the coils can be determined more freely.

Moreover, in the electronic equipment of the above-described embodiment, at least one of the electric power receiving coils preferably includes a cable that is connected to the electronic component built in the first case.
Thereby, since the electric power receiving coils are connected with each other, only one of the coils is necessary to be connected to the electronic component that has an electric power receiving circuit, so that the cost of the electronic equipment can be saved.

Also, in the electronic equipment of the above-described embodiment, at least one of the electric power receiving coils preferably includes a cable that is connected to the conductor component built in the second case.
Thereby, since the electric power receiving coils are connected with each other, only one of the coils is necessary to be connected to the conductor component that has the electric power receiving circuit, so that the cost of the electronic equipment can be saved.

Further, examples of the electronic equipment of the above-described embodiment include equipment that is applied to a handy printer in which the second case incorporates a roiled paper. Thereby, electric power can be transmitted wirelessly to the handy printer.

### EXAMPLES

Hereinafter, this embodiment will be described in detail with reference to the accompanying drawings.

### Example 1

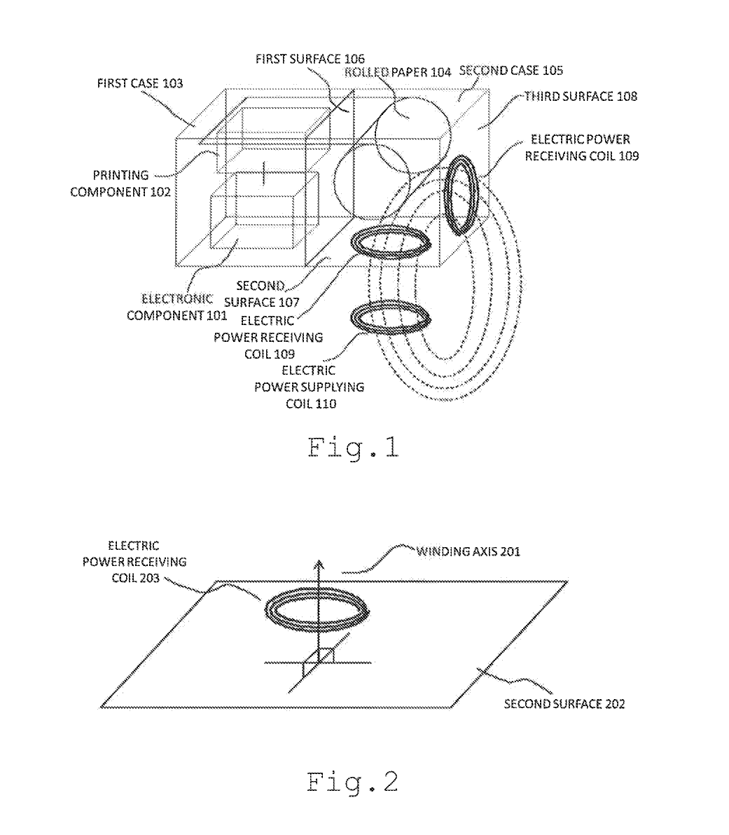

Electronic equipment having a wireless electric power transmitting device according to Example 1 will be explained below. In Example 1, the electronic equipment is applied to a handy printer. As shown in FIG. 1, a first case 103 that incorporates an electronic component 101 and a printing component 102, and a second case 105 that incorporates a roiled paper 104 are structured to be connected with each other. Then, the second case has a first surface 106 that is common with a surface of the first case. Further, the second case has a second surface 107 that has an angle with respect to the first surface and a third surface 108 that has an angle with respect to the second surface. Then, electric power receiving coils 109 are built in parts that face respectively the second surface and the third surface. According to such a structure of the handy printer, when the handy printer incorporates the electric power receiving coils, wireless electric power transmission can be achieved with high efficiency without using a magnetic material.

Firstly, each component will be explained, and thereafter, effects of this example will be described.

The first case 103 incorporates the electronic component 101 and the printing component 102. Herein, the electronic component may be a battery for moving the printing component or a power source circuit. Also, the electronic component may be a circuit board on which an electronic component having a function to receive printing data from a personal computer or the like and convey the received printing data to the printing component is mounted. Moreover, the electronic component may also be a camera, a barcode reader or an RFID reader/writer for acquiring the printing data. The electronic component may be an arbitrary electronic component. In addition, the printing component is structured by a printer head, ink and the like, and has a function of printing.

The second case 105 incorporates the rolled paper 104. This rolled paper is used with the printing component in the first case. Herein, the rolled paper may be simply a sheet of paper. Alternatively, the rolled paper may be a sheet of paper on which characters, lines or the like are printed in advance. Also, the rolled paper may be an adhesive sheet which can be used as a sticker after being printed.

The first case 103 and the second case 105 are connected with each other so as to structure the handy printer, and have the first surface 106 in their common part at their connection. Then, the second case 105 has the second surface 107 that has an angle with respect to the first surface. Further, the second case 105 has the third surface 108 that has an angle with respect to the second surface. Each of the surfaces may have an arbitrary shape.

The electric power receiving coils 109 are built in the parts that face respectively the second surface and the third surface. The electric power receiving coils are made of conductors that are wound in coils. Herein, the conductor may be structured by one line, tied plural lines or a litz wire obtained by tying plural insulated lines.

Also, the coil may be wound planarly or sterically. Moreover, the coil may be wound to have an arbitrary outer shape, such as circular, elliptical, rectangular and hexagonal shapes.
Then, the electric power receiving coils are built in the parts chat face respectively the second surface and the third surface.

Next, the effects of this example will be explained.

A structure where an electric power supplying coil 110 is positioned below the handy printer as illustrated in FIG. 1 will be assumed. Herein, an electric transmission circuit such as a high-frequency power source is connected to the electric power supplying coil, which is not illustrated. High-frequency energy that is output from this high-frequency power source is input into the coil. When the high-frequency energy is input into the coil, current flows in the coil, so that magnetic lines are formed in a space by this current. The magnetic lines of this example are illustrated in FIG. 1.

In this example, magnetic lines 111 generated by the electric power supplying coil pass through the electric power receiving coil which is built in the second surface, and then pass through the electric power receiving coil which is built in the third surface. Thereafter, the magnetic lines 111 return to the electric power supplying coil. As described above, when the magnetic lines are formed, current flows in the electric power receiving coils so as to transmit energy. In this example, the electric power is transmitted with the magnetic lines shown in FIG. 1.

Here, since the magnetic lines are as shown in FIG. 1, leakage of the magnetic lines toward the first case that incorporates the electronic component can be small. As a result, the electric power can be transmitted also to the handy printer including the electronic component without using a magnetic material. Further, the rolled paper that is built in the second case and the magnetic lines are in the same case. However, only a small amount of eddy current is generated in an insulator such as the rolled paper, so that the degradation of the transmitting efficiency can be suppressed.

As explained above, in the handy printer of this example, the shapes of the magnetic lines can be controlled by incorporating the electric power receiving coils respectively in the second surface and the third surface of the second case, whereby the wireless electric power transmission can be achieved with high efficiency even without using a magnetic material.

Incidentally, this example is not limited to the above-described case, but can be applied to various types of equipment in which the insulator component is built in the second case.

### Example 2

A handy printer having a wireless electric power transmitting device according to Example 2 will be explained. In this example, the first surface is made of a conductor. Then, a conductivity of the conductor that structures the first surface is higher than an equivalent conductivity of the electronic components that are built in the first case. Thereby, the transmitting efficiency can be enhanced.

Herein, as shown in FIG. 1, the case where magnetic lines leak toward the first case without being limited by the second case will be assumed. In this case, by the magnetic lines that leak toward the first case, eddy current is generated in the electronic components that are built in the first case, thereby degrading the transmitting efficiency. Then, the first surface that is a common surface is made of the conductor. If the first surface is made of the conductor, the magnetic lines are shielded by the conductor, thereby reducing a loss in the electronic components that are built in the first case.

However, since such eddy current is generated in the first surface, the transmitting efficiency is degraded. In this example, in order to reduce the loss by the eddy current that flows in the first surface, the conductivity of the first surface is set to be higher than the equivalent conductivity of the electronic components that are built in the first case. Herein, the electronic components that are built in the first case denote all components that are built in the first case. Then, if the components have different conductivities, the equivalent conductivity means their averaged conductivity.

Under a condition that an amplitude of the eddy current that flows in the conductor is constant, the conductivity of the conductor is in proportion to the loss. Thus, in this example, since the conductivity of the conductor in which the eddy current flows is high, the loss is small, whereby the wireless electric power transmission can be achieved with high efficiency.

As explained above, in this example, the first surface that is the common surface is made of the conductor, and the conductivity of this conductor is set to be higher than the equivalent conductivity of the electronic components that are built in the first case, whereby the loss by the magnetic lines that leak toward the first case can be reduced, so that the wireless electric power transmission can be achieved with high efficiency.

Incidentally, the equivalent conductivity and the conductivity of the common surface can be compared as follows. Firstly, ail of the electronic components that are built in the first case are prepared. Next, while electric power is transmitted wirelessly by using coils, the electronic components that are built in the first case are sandwiched by the coils so as to measure their transmitting efficiency. This efficiency is denoted by η (electronic components). Thereafter, a conductor that has the same shape as the electronic components built in the first case and is in the same kind as the first surface is sandwiched by the coils so as to measure its transmitting efficiency. This efficiency is denoted by η (conductor). If η (electronic components) is lower than η (conductor), the conductivity of the conductor is higher than the equivalent conductivity of the electronic components.

### Example 3

A handy printer having a wireless electric power transmitting device according to Example 3 will be explained. In this example, the first surface is made of an insulator. Thereby, the transmitting efficiency can be enhanced.

Similarly to Example 2, the magnetic lines may leak toward the first case. In this case, by structuring the first surface by such an insulator, eddy current generated in the first surface can be reduced. As a result, an energy loss can be reduced, whereby the wireless electric power transmission can be achieved with high efficiency.

Herein, the insulator may be made of expanded polystyrene, plastics or the like. Alternatively, the insulator may also be made of air.

As described above, in this example, since the first surface is made of the insulator, the eddy current generated in the first surface by the magnetic lines that leak toward the first case can be reduced, whereby the wireless electric power transmission can be achieved with high efficiency.

A modified example of the electric power receiving coil will be described below. FIG. 2 illustrates an electric power receiving coil 203 that is built in a part that faces a second surface 202. A winding axis 201 of this coil is perpendicular to the second surface 202. By disposing the coil as described above, a space inside the second case can be larger. As a result, a larger rolled paper can be built in the second case.

### Example 4

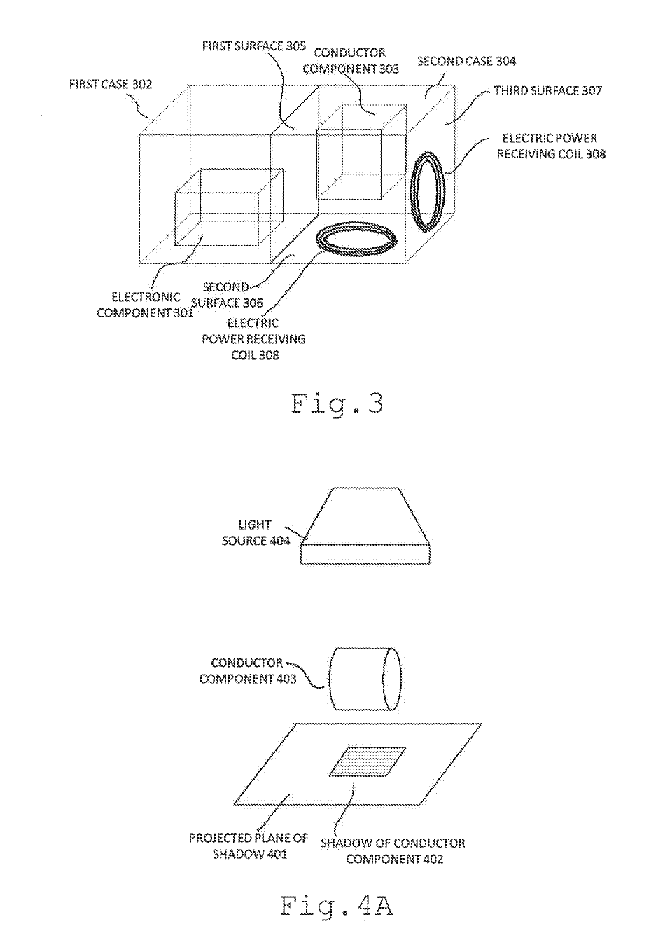

Example 4 will be explained. As shown in FIG. 3, it is characterized in that a conductor component 303 whose resonant frequency is different front a frequency that is supplied or received by an electric power receiving coil is built in the second case. Since such a conductor component can be built in the second case, the first case can be reduced in size.

When the second case incorporates the conductor component, eddy current flows in the conductor component, and a loss is generated. Impact of this eddy current becomes largest, when the conductor component resonates at a radio wavelength. That is, unless using a conductor that resonates, no practical problem may occur.

For example, the conductor that resonates may have a shape of a linear bar having a length of a half wavelength. Also, the length may be an integral multiple of a half wavelength. The shape of the conductor that resonates may also be a planar plate whose outer diameter is one wavelength. Further, the outer diameter may also be one wavelength plus an integral multiple of a half wavelength. Moreover, the conductor that resonates may have a complicated shape. Herein, the wavelength means a wavelength at the frequency used for the wireless electric power transmission.

As explained above, such a conductor component can be built in the second case.

### Modified Example

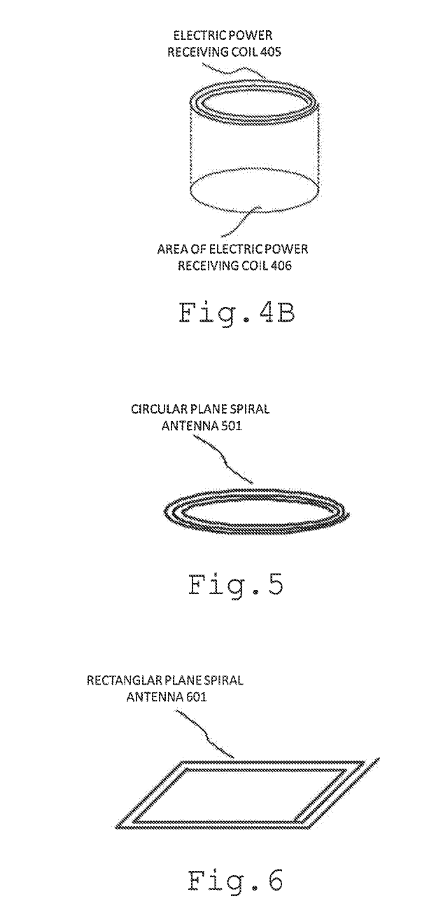

A modified example of the conductor component that can be built in the second case will be explained below. As shown in FIGS. 4A and 4B, the second case may incorporate a conductor component 403 whose shadow 402, which is formed on a projected plane 401 when the conductor component 403 is illuminated with light at an arbitrary angle by a light source 404, has an area smaller than an area 406 of the electric power receiving coil 405.

Also, a conductor component whose resonant frequency is different from a transmitting frequency may be built in combination with a conductor component whose area is smaller than the area of the electric power receiving coil, or a plurality of such conductor components may be built in the second case. As described above, by incorporating such a lot of components into the second case, the number of the components to be built in the first case becomes smaller, whereby the first case can be reduced in size.

A modified example of the electric power receiving coil will be explained below. As illustrated in FIG. 5, the electric power receiving coil may be structured by a self-resonant coil that has a shape of a circular spiral antenna 501. Alternatively, as shown in FIG. 6, the electric power receiving coil may also be structured by a self-resonant coil that has a shape of a rectangular spiral antenna 601. By using such a self-resonant coil, a transmitting distance can be longer, so that the position of the electric power receiving coil can be determined more freely.

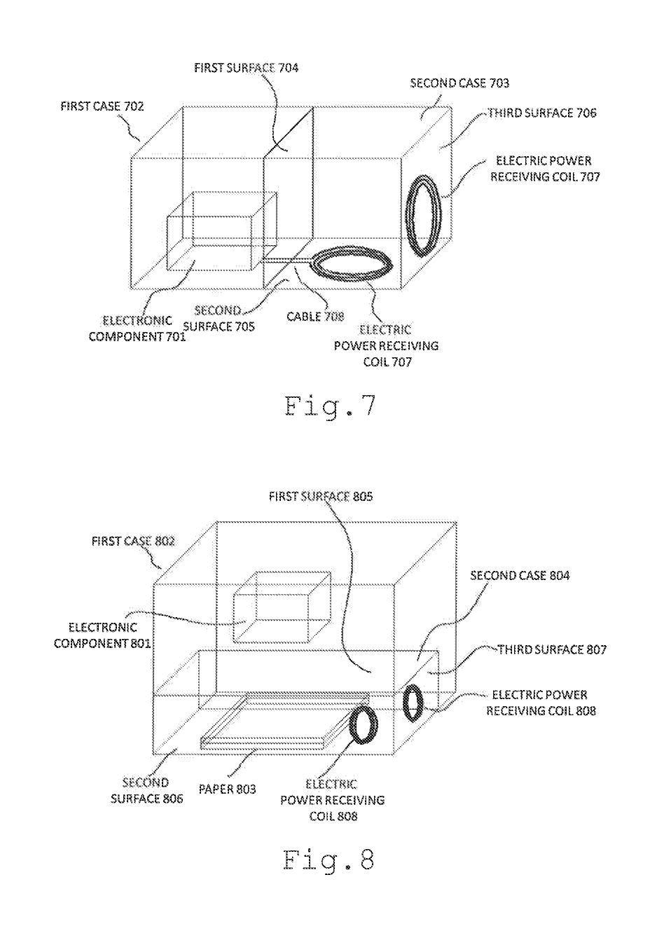

Moreover, as shown in FIG. 7, one of the electric power receiving coils 707 may include a cable 708 connected to an electronic component 701 that is built in the first case 702. Since the electric power receiving coils are connected with each other, only one of the coils is necessary to be connected to the electronic component that has the electric power receiving circuit, whereby the cost of the electronic equipment can be saved.

Further, one of the electric power receiving coils may include a cable connected to the conductor component that is built in the second case. Since the electric power receiving coils are connected with each other, only one of the coils is necessary to be connected to the conductor component that has the electric power receiving circuit, whereby the cost of the electronic equipment can be saved.

Modified examples of the first case and the second case will be described below. FIG. 8 illustrates an example of a printer. An electronic component 801 is built in a first case 802, and a sheet of paper 803 is stored in a second case 804.

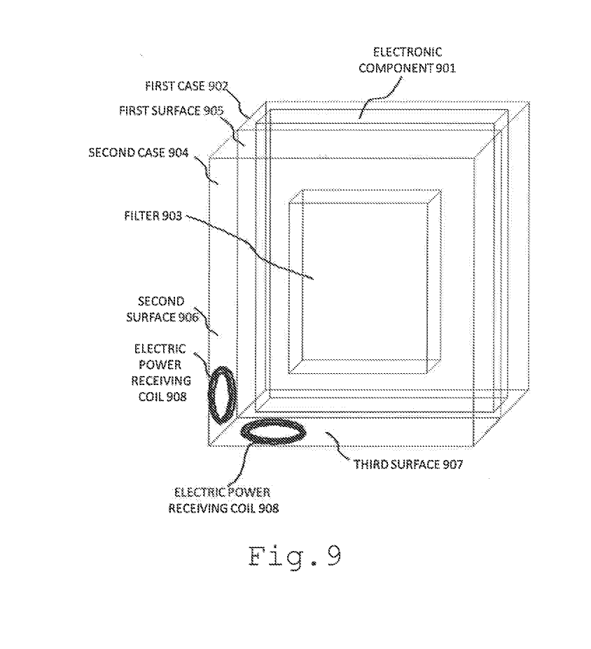

FIG. 9 illustrates an example of an air cleaner. An electronic component 901 is built in a first case 902, and a filter 903 is built in a second case 904.

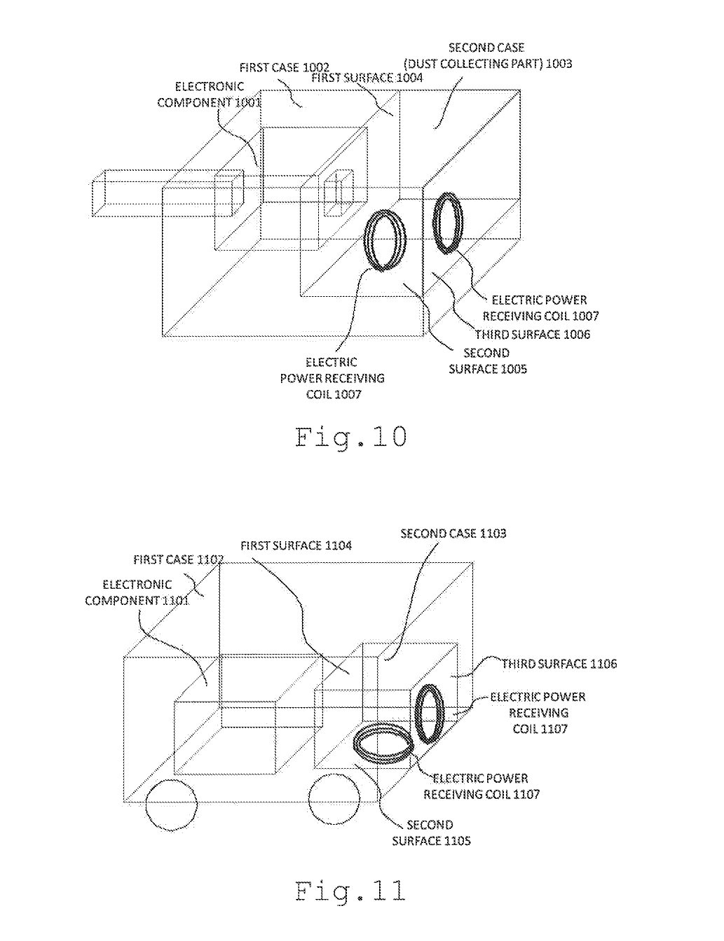

FIG. 10 illustrates an example of a vacuum cleaner. An electronic component 1001 such as a motor is built in a first case 1002, and a second case 1003 is a dust collecting part into which dust including dirt and trash are put.

FIG. 11 illustrates an example of an electric vehicle. An electronic component 1101 such as a motor is built in a first case 1102. A body of this electric vehicle is made of resin, and electric power can be transmitted to a coil that is built therein.

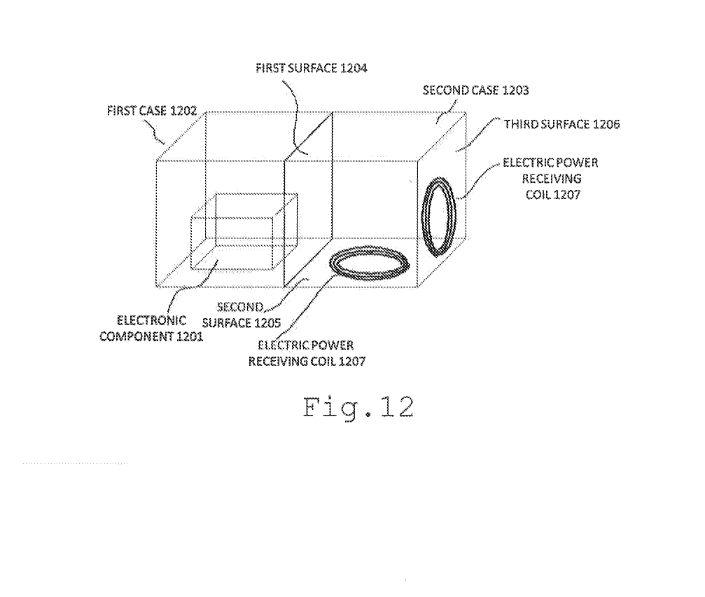

FIG. 12 illustrates a structure where a second case 1203 does not incorporate an insulator. According to such a structure in which nothing is incorporated, degradation of the efficiency is significantly small, so that the wireless electric power transmission can be achieved with high efficiency

Incidentally, in the above-described explanations, the case where the electronic equipment receives the electric power has been assumed; however, those explanations can be applied also to the case where the electronic equipment supplies the electric power reversely.

Moreover, the above-described embodiment can be used even for the purposes other than the wireless electric power transmission. For example, wireless communication can be achieved by modulating a high-frequency wave that is to be transmitted. In this case, as hardware for the supplying and receiving, hardware for wireless communication may be utilized.

According to the embodiment that has been described above variously, the wireless electric power transmitting means can prevent the electric power loss that is caused by a magnetic material, and further can realize the weight reduction, the cost savings, the electric power increment, the resonant frequency control, the thickness reduction of the coils and the like of the electronic equipment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic equipment comprising:
a first case that incorporates an electronic component;
a second case having a first surface that is common with a surface of the first case, a second surface that has an angle with respect to the first surface and a third surface that has an angle with respect to the second surface; and
electric power receiving coils built in parts that face respectively the second surface and the third surface.

2. The electronic equipment according to claim 1, wherein the first surface is made of a conductor, and a conductivity of the conductor structuring the first surface is higher than an equivalent conductivity of the electronic component that is built in the first case.

3. The electronic equipment according to claim 1, wherein the first surface is made of an insulator.

4. The electronic equipment according to claim 1, wherein each of the second surface and the third surface is made of an insulator.

5. The electronic equipment according to claim 1, wherein winding axes of the electric power receiving coils are perpendicular to the second surface and the third surface respectively.

6. The electronic equipment according to claim 1, wherein the second case incorporates a conductor component having a resonant frequency that is different from a frequency received by the electric power receiving coil.

7. The electronic equipment according to claim 1, wherein the second case incorporates a conductor component whose shadow, which is formed on a projected plane when the conductor component is illuminated with light at an arbitrary angle, has an area smaller than an area of the electric power receiving coil.

8. The electronic equipment according to claim 7, wherein the second case incorporates a plurality of the conductor components.

9. The electronic equipment according to claim 1, wherein the electric power receiving coil is made of a self-resonant coil.

10. The electronic equipment according to claim 1, wherein at least one of the electric power receiving coils includes a cable that is connected to the electronic component built in the first case.

11. The electronic equipment according to claim 8, wherein at least one of the electric power receiving coils includes a cable that is connected to the conductor component built in the second case.

12. A handy printer according to claim 1, wherein the second case incorporates a rolled paper.

13. (canceled)

14. (canceled)
